(19) United States
(12) Patent Application Publication
(10) Pub. No.: US 2012/0262159 A1
(43) Pub. Date: Oct. 18, 2012

(54) PUMP LINE LINEAR POSITION SENSING ASSEMBLY

(75) Inventors: Christopher J. Pellin, Burnsville, MN (US); Joseph E. Tix, Hastings, MN (US); Mark T. Weinberger, Mounds View, MN (US); Jeffrey N. Velgersdyk, Minnetonka, MN (US)

(73) Assignee: Graco Minnesota Inc., Minneapolis, MN (US)

(21) Appl. No.: 13/505,857

(22) PCT Filed: Nov. 3, 2010
(86) PCT No.: PCT/US10/55210

§ 371 Date: May 3, 2012

Related U.S. Application Data
(60) Provisional application No. 61/257,903, filed on Nov. 4, 2009.

(51) Int. Cl. G01B 7/14

(52) U.S. Cl. 324/207.24

(57) ABSTRACT

A two-piece collar (10) is rigidly clamped onto the hydraulic driver shaft (12) via two shoulder bolts (14). The collar halves (16) engage a tightly toleranced groove feature (18) on the spool (20) that is assembled onto the linear sensor shaft (22). The spool (20) houses a magnet (24) that sends a position signal to the sensor (26). As the hydraulic driver shaft (12) reciprocates during operation, the spool (20) moves along with it sending the position signal to the sensor (26) that tells the driver (28) to change direction. The hydraulic driver and chemical pump shafts (12) can slowly rotate over time, which is preferred for increased chemical pump/hydraulic driver seal life.

### TECHNICAL FIELD

This application claims the benefit of U.S. Application Ser. No. 61/257,903, filed Nov. 4, 2009, the contents of which are hereby incorporated by reference.

### BACKGROUND ART

### Disclosure of the Invention

A linear position sensing assembly couples the pump line hydraulic driver to a magnetic spool that reads position on the sensor while allowing for hydraulic and chemical pump shaft rotation.

In FIGS. 1 and 2, a two-piece collar (1) is rigidly clamped onto the hydraulic driver shaft (2) via two shoulder bolts (3). The collar halves engage a tightly toleranced groove feature on the spool (4) that is assembled onto the linear sensor shaft (5). The spool houses a magnet (6) that sends a position signal to the sensor. As the hydraulic driver shaft reciprocates during operation, the spool moves along with it sending the position signal to the sensor that tells the driver to change direction.

There are a number of advantages to this construction—there is a minimal part count and the design is simple. The hydraulic driver and chemical pump shafts can slowly rotate over time, which is preferred for increased chemical pump/hydraulic driver seal life. Previous linear sensing assembly concepts had additional components/features that limited shaft rotation to successfully operate. The invention allows for full 360-degree rotation due to the collar/spool coupling geometry while maintaining precise location sensing.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows a cross-section of the position-sensing assembly of the instant invention.

FIG. 2 shows a partial cross-section showing the collar clamped to the pump shaft.

### BEST MODE FOR CARRYING OUT THE INVENTION

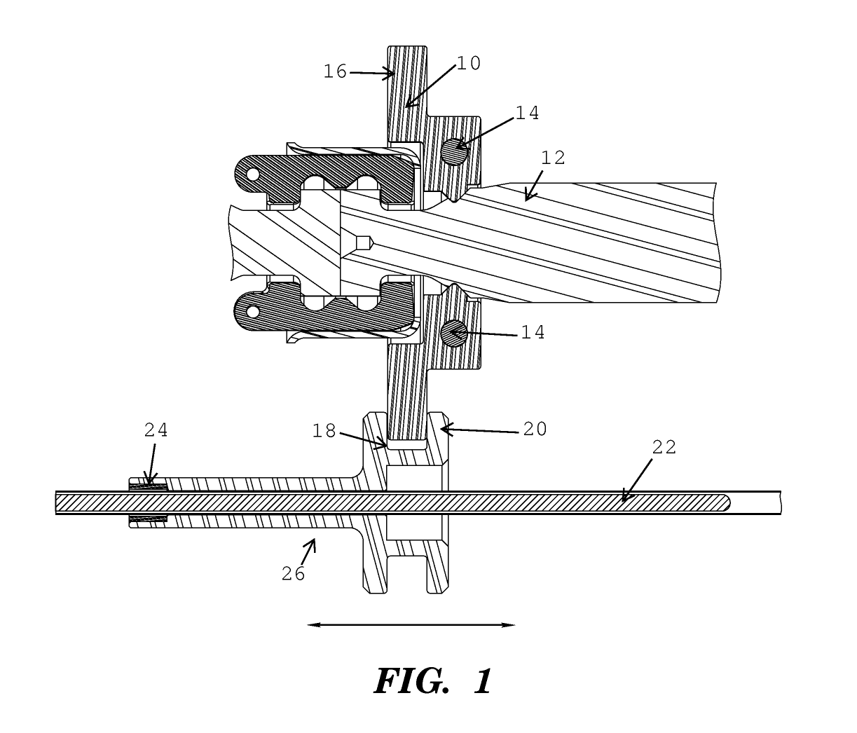

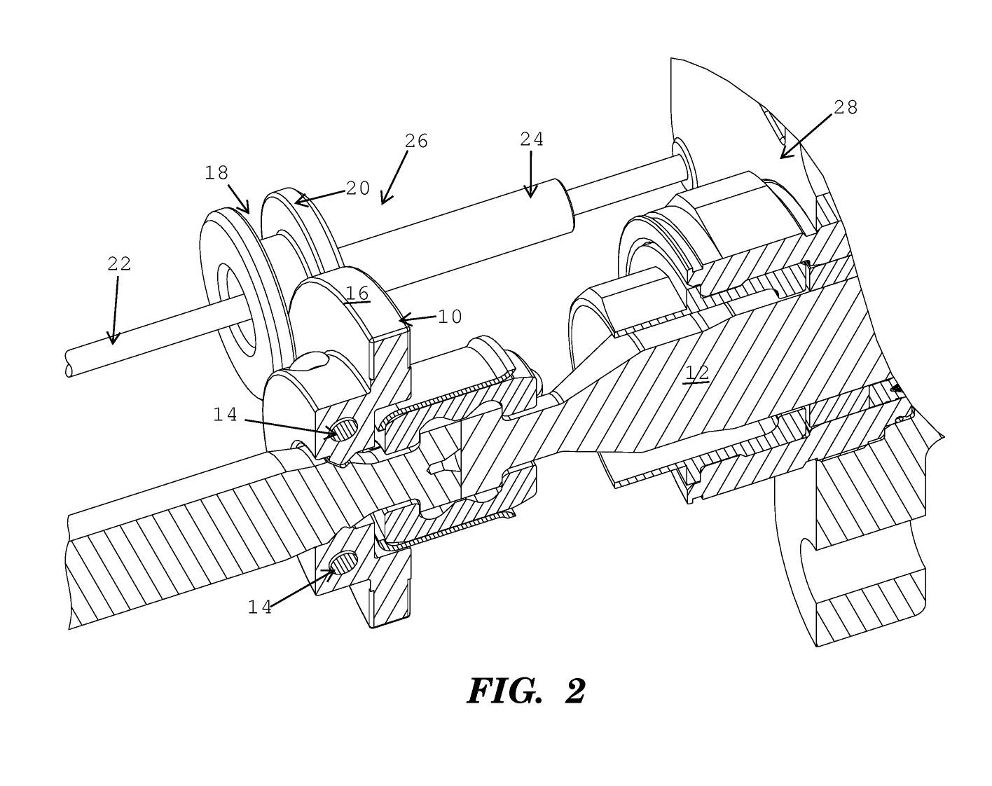

In FIGS. 1 and 2, a two-piece collar 10 is rigidly clamped onto the hydraulic driver shaft 12 via two shoulder bolts 14. The collar halves 16 engage a tightly toleranced groove feature 18 on the spool 20 that is assembled onto the linear sensor shaft 22. The spool 20 houses a magnet 24 that sends a position signal to the sensor 26. As the hydraulic driver shaft 12 reciprocates during operation, the spool 20 moves along with it sending the position signal to the sensor 26 that tells the driver 28 to change direction. The hydraulic driver and chemical pump shafts 12 can slowly rotate over time, which is preferred for increased chemical pump/hydraulic driver seal life.

It is contemplated that various changes and modifications may be made to the position sensing assembly without departing from the spirit and scope of the invention as defined by the following claims.

1. A position sensing assembly for use with an apparatus having a fixed portion and a reciprocating shaft, said assembly comprising:
a collar attached to said reciprocating shaft;
a linear sensor comprising a shaft element and a magnet element; and
a spool containing one of said elements, the other of said elements being fixed to said fixed portion, said collar engaging said spool to permit rotation of said collar relative to said spool while engaging said spool to reciprocate in correspondence with said shaft.
